(19) United States
(12) Patent Application Publication
(10) Pub. No.: US 2015/0180582 A1
(43) Pub. Date: Jun. 25, 2015

(54) TRANS-IMPEDANCE AMPLIFIERS (TIA) THERMALLY ISOLATED FROM OPTICAL MODULES

(71) Applicants: Dacheng Zhou, Fort Collins, CO (US); Daniel Alan Berkram, Loveland, CO (US)

(72) Inventors: Dacheng Zhou, Fort Collins, CO (US); Daniel Alan Berkram, Loveland, CO (US)

(21) Appl. No.: 14/406,792

(22) PCT Filed: Aug. 13, 2012
(86) PCT No.: PCT/US2012/050545

§ 371 Date: Dec. 10, 2014

(51) Int. Cl. H04B 10/564; H04B 10/69

(52) U.S. Cl. CPC H04B 10/564; H04B 10/693

(57) ABSTRACT

A system includes a Trans-Impedance Amplifier (TIA) to amplify an input signal from an optical module. The TIA is to interface with the optical module via a transmission line and a reference ground routed next to the transmission line. The transmission line and reference ground are to thermally isolate the TIA from the optical module. An impedance control is to cause an impedance adjuster to match an input impedance of the TIA to a transmission line impedance.

### BACKGROUND

In optical communications, an input optical pulse from an optical fiber may be received and converted into an electrical current through an optical module. The optical module may have a high output impedance. A Trans-impedance amplifier (TIA) may be used to convert input current into voltage output, and may generate heat. Because the photo-current from the optical module is very small, and the output impedance of the optical module is very high, the TIA is typically placed right next to the optical module. However, the optical module may be thermally sensitive and suffer drawbacks due to the proximity to the TIA.

### BRIEF DESCRIPTION OF THE DRAWINGS/FIGURES

FIG. 1 is a block diagram of a system including a Trans-Impedance Amplifier (TIA) according to an example.

FIG. 2 is a block diagram of a system including a TIA according to an example.

FIG. 3A is a block diagram of a TIA according to an example.

FIG. 3B is a block diagram of a TIA according to an example.

FIG. 4A is a block diagram of a Continuous-Time Linear Equalizer (CTLE) according to an example.

FIG. 4B is a block diagram of a CTLE according to an example.

FIG. 5 is a flow chart based on amplifying an input signal according to an example.

### DETAILED DESCRIPTION

Example systems provided herein may address heat generation of components in communication with each other, by thermally isolating components. Furthermore, it is possible to avoid transmission line effects for component communication, even when communication involves low current, high impedance components such as photo diodes or other optical components to be amplified. To reduce the reflection from transmission line effects, an amplifier such as an exemplary Trans-Impedance Amplifier (TIA) may include impedance matching to match the transmission line impedance. In addition, example systems may address the very low current pulse from the optical source by exemplary techniques of routing a reference ground next to a signal transmission line, to be delivered into the TIA as a ground reference. Such exemplary interconnect techniques can minimize any noise coupling to the interconnect.

Thus, the examples described herein enable the integration of a TIA chip into other components, e.g., based on a single application-specific integrated circuit (ASIC) or other solution. Therefore, overall system cost, latency, and power consumption may be reduced. Furthermore, a thermal solution for the TIA (e.g., an ASIC or other chip/package including the TIA) may be addressed separately from a thermal solution for the optical module (which is extremely sensitive to temperatures), thus additional design flexibility and relaxed thermal constraints are enabled for a TIA and its related ASIC/chip implementations. For example a first solution may involve an active heatsink to dissipate heat from the TIA, and a second solution may involve a minimal passive heatsink to dissipate heat from the optical module 130 (or vice versa, depending on a particular optimization for a particular component considered independently).

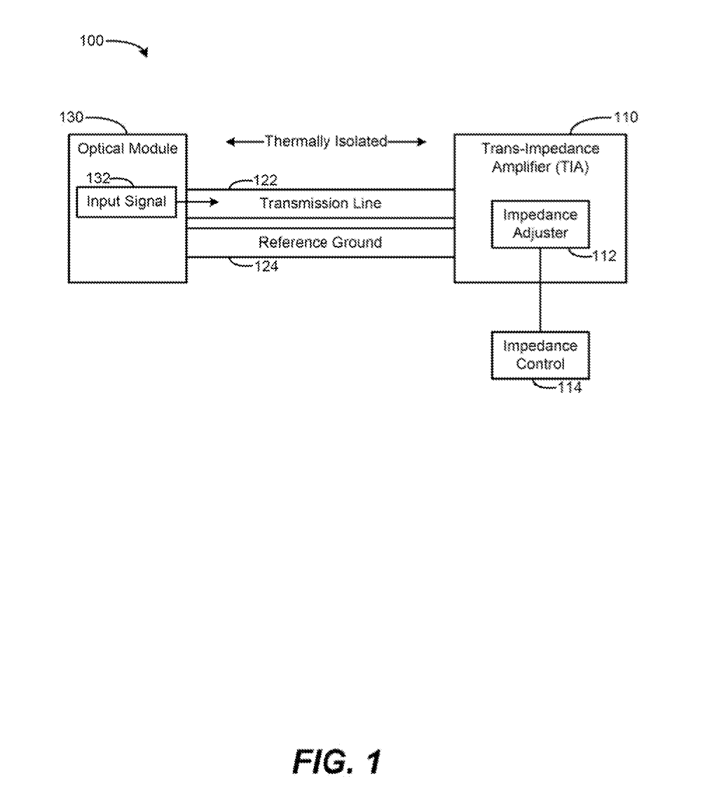

FIG. 1 is a block diagram of a system 100 including a Trans-Impedance Amplifier (TIA) 110 according to an example. The system 100 also includes an optical module 130 thermally isolated from the TIE 110 by transmission line 122 and reference ground 124. The optical module 130 is to receive an input signal 132 that is to be amplied by the TIA 110. The TIA 110 includes an impedance adjuster 112 that is adjustable based on the impedance control 114.

The optical module 130 may be built and packaged in a process separately from the TIA 110. For example, the optical; module 130 may include discrete optical components assembled together using a non-silicon assembly process, separately from other electrical components (such as an ASIC to contain the TIA 110) through a Complementary Metal-Oxide-Semiconductor (CMOS) fabrication process. The optical components and other features of the optical module 130 may be sensitive to thermal issues. By physically separating the optical module 130, a thermal solution for the optical components may be separately designed and optimized specifically for the optical module 130. In other words, thermal isolation between the optical module 130 and the TIA 110 prevents heat from the TIA 110 from negatively affecting performance of the optical module 130; the optical module 130 is thermally decoupled from the TIA 110. Thermally isolating the optical module 130 avoids a liability of diminishing an operational lifetime and performance of optical elements (e.g., a photodiode or other detector) that are sensitive to heat. For example, an operational lifetime of thermally isolated optical components at 25 degrees Centigrade (25 C) is far longer than operating them at 70 C without thermal isolation.

The TIA 110 is to convert and/or amplify the input signal 132, which may be a small photo-current, to a high-swing voltage, for example. Such amplification may discourage separation between the optical module 130 and TIA 110 due to transmission effects, and examples provided herein address such issues to enable separation and thermal isolation. The TIA 110 may be built and packaged based on CMOS processes, such as Bipolar junction transistor Complementary Metal-Oxide-Semiconductor (BiCMOS) technology. Thus the TIA 110 is compatible with technology used on other components for system 100, such as a main functional ASIC based on CMOS processing. Thus, there is no need to place the TIA 110 chip next to the optical module 130 in examples provided herein. However, in an example, the TIA 110 may be a separate component from an ASIC that is placed further away from the TIA 110 based on a package interconnect and/or a board-level interconnect. Integrating the TIA 110 chip into the main ASIC can reduce overall cost, power, and latency by avoiding a need for an additional/separate chip. Even with such integration, examples provided herein can address reflection issues with transmission line effects, avoid coupling noise issues that may arise due to the very small input signal 132 (e.g., a photo-current), and provide thermal isolation for the optical module 130 while integrating the TIA 110 design with other components (e.g., integration of the TIA 110 on a main ASIC).

The TIA 110 is to receive the input signal 132, which may be a single-ended signal (e.g., based on a light sensor diode that turns on and off). The TIA 110 may convert the input signal 132 to a differential signal, so that a differential linear amplifier or other stage downstream of the TIA 110 can amplify the output of the TIA 110 based on a common mode. Furthermore, a differential signal may be used to mute power supply noise.

The optical module 130 and TIA 110 may be based on various packaging solutions. The optical module 130 and TIA 110 may be separately packaged, co-packaged, or packaged based on other designs. A co-packaged design may provide the optical module 130 on one package substrate, the TIA 110 (e.g., integrated with an ASIC, for example) on another package substrate, and a third package substrate to interconnect the TIA 110 and optical module 130. Packaging solutions may provide enough distance between the TIA 110 and optical module 130 for thermal isolation, even though a solution may not necessarily involve different packages, and components may be on the same substrate. Package substrate material may include organic package substrate ceramic package substrates, and other substrates. Various integrated circuit package techniques also may be used to package components together or separately. The packaging solution is to thermally isolate the optical module 130 and TIA 110, and that can be achieved based on a common package, by having the TIA 110 and optical module 130 on two different packages/substrates that are both on the same board, and other combinations/arrangements. Thus, there is no need for components to be bonded to or otherwise part of the same chip that would tie thermal issues among all those components. Thus, solutions provide a high level of integration (e.g., enabling the TIA 110 to be integrated with other components), while enabling granularity of thermal solutions due to thermal isolation of the optical module 130 and/or other thermally sensitive components.

Separating the TIA 110 from the optical module 130 may raise the issue of “transmission line effect,” which may depend on the data rate used. In an example, 10 gigabit or 25 gigabit data rates may be used. Conductor losses, dielectric losses, and other characteristics may further be affected by the data rate, and exacerbated by a length of the transmission line. Thus, the reference ground 124 may be routed next to the transmission line 122, for the interconnect between the optical module 130 and the TIA 110. Such routing of the reference ground 124 next to the transmission line 122 may avoid inductive coupling between wires.

A photodetector or other component of the optical module 130 may have a relatively high impedance. To maintain high bandwidth across the transmission line 122, a relatively low impedance may be used for the transmission line 122. Similarly, it is not desirable to match components of the optical module 130 with very high impedance input to avoid negatively affecting bandwidth capability. In an example, a typical photodiode impedance is on the order of K-Ohms of impedance, and typical trace impedance associated with the transmission line 122 (for bandwidth) may be chosen on the order of approximately 50-70 Ohms. Thus, additional techniques may be used for impedance matching.

Another exemplary technique for mitigating transmission line effects is based on the impedance control 114 to control the impedance adjuster 112, to adjust an input impedance of the TIA 110. The impedance control 114 may be, for example, an impedance programmable control logic to control the impedance adjuster 112 of the TIA 110. The impedance adjuster 112 may be formed in the TIA 110 package, and may be based on post-silicon trimming or other dynamic adjustment. The impedance control 114 and/or impedance adjuster 112 may be adjusted based on output of the system 100 (e.g., based on an eye diagram) and controlling the impedance based on the output. In an example, the impedance adjuster 112 may be a termination resistor (e.g., a passive feedback resistor that is trimmable). Impedance control and tuning may be used to mitigate any interconnect mismatch, by calibrating the termination resistor. For calibration, an output eye diagram may be examined during testing while adjusting various current to look at voltage changes, or other various techniques (including those that can be implemented post-silicon such as fixed-fused programming).

The input impedance of the TIA 110 may depend on the structure of the TIA 110, such as a gain and/or bias of the TIA 110 that may be controllable in various examples, whether the TIA 110 relies on feedback or not, and other factors that are represented by the impedance adjuster 112. The impedance control 114 is to be compatible with and interact with the structure and functionality of the impedance adjuster 112 and other related aspects of the TIA 110. The impedance control 114 is shown as separate from the TIA 110, although in alternate examples the impedance control 114 may be integrated into the TIA 110. Thus, the impedance adjuster 112 and/or the impedance control 114 may provide impedance calibration for the system 100.

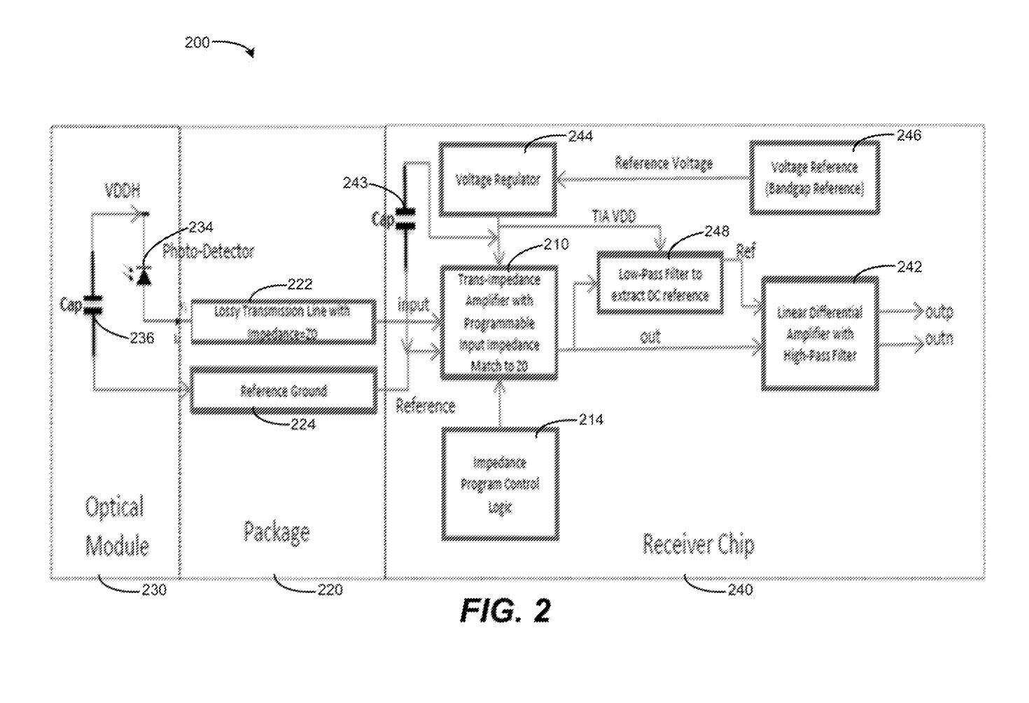

FIG. 2 is a block diagram of a system 200 including a TIA 210 according to an example. The system 200 may be an optical receiver system that includes an optical module 230, interconnect 220, and receiver chip 240. The optical module 230 includes a first capacitor 236 and an optical component 234. The interconnect 220 includes transmission line 222 and reference ground 224. The reference ground 224 may be routed next to the transmission line 222. The receiver chip 240 includes TIA 210, impedance control 214, differential amplifier 242, second capacitor 243, voltage regulator 244, voltage reference 246, and filter 248.

The interconnect 220 is to separate the optical module 230 from the receiver chip 240 (e.g., an ASIC including the TIA 210) by a distance to provide thermal isolation, e.g., based on a package or board arrangement. An input impedance of the TIA 210 is to match a transmission line impedance (e.g., Z0). In an example, impedance values may include an transmission impedance value of around 50-70 Ohms, for transmitting an input signal from the optical component 234 (photo-detector) on the order of 100 microamps. An output impedance around of the optical component 234 may on the order of 100 KOhms, and may be scaled to avoid noise.

The optical module 238 may be a rely optical arrangement, such as an optical device having its own packaging. The receiver chip 240 may be part of ASIC, host device, central processing unit (CPU), or other component. The optical module 230 and receiver chip 240 are to connect through the interconnect 220 (transmission line 220), which may be a package. Thus, the interconnect 220 is to provide a distance between the optical module 230 and the receiver chip 240, enabling thermal isolation. The receiver chip 240, such as an ASIC, may be fabricated based on normal silicon processes. Examples enable multiple different processes to be put on the same package, enabling separation of real optical components in the optical module 230 from electrical/silicon components of the receiver chip 240. Any mismatch between the optical module 230 and receiver chip 240 may be addressed by tuning the termination to match the interconnect 220, to reduce reflection. At the same time, it is possible to avoid heat transfer from the electrical components of the receiver chip 240 to the real optical components of the optical module 230

In an example optical module 230, optical component 234 may be a photo-diode reverse-biased with high voltage, shown as VDDH, and reference ground 224. A relatively large first capacitor 236 may be used to form an alternating current (AC) path from VDDH to ground. A second capacitor 243 may be used to provide a complete AC return-loop to avoid any capacitive and inductive noise. The photo-current and reference ground associated with the optical module 230 may be connected to the interconnect 220 package, which has a signal trace for transmission line 222 and a trace for reference ground 224 routed next to the transmission line 222, to minimize any capacitive and inductive noise. The trace impedance may be designed to be as high as possible to optimize signal-to-noise ratio.

On the receiver chip 240, he transmission line 222 and reference ground 224 are connected to the TIA 210, which may be integrated into and/or isolated from the rest of the receiver chip 248 (e, g an ASIC). A voltage regulator 244 and voltage reference 246 (e.g., bandgap reference) may be used to provide clean supply voltage (VDD) for the TIA 210. Second capacitor 243 may be connected between the supply voltage VDD for the TIA, and reference ground 224, to provide an AC path to minimize capacitive and inductive coupling noises. The TIA 210 may include impedance control 214 (and an impedance adjuster in the TIA 210, not shown) to trim an input impedance of the TIA 210 to match an impedance of the interconnect 220, to minimize reflection noise. A low-pass filter 248 may be used to extract a direct current (DC) common mode. A differential amplifier 242, such as a continuous-time linear equalizer (CTLE) may be used to convert output of the TIA 210, and DC common mode from the filter 248, if applicable, into a differential output that can be processed by components further downstream, such as other ASICs.

The voltage regulator 244 is to provide clean voltage, independent outside voltage variations, to supply the TIA 210. In alternate examples, the voltage reference 246 may be integrated with the voltage regulator 244. A bandgap reference, or other type of reference, may be used to provide the desired voltage. The voltage reference 246 may be a temperature independent reference to provide true and consistent voltage across all environmental conditions.

The filter 248 (e.g., a low-pass filter (LPF)) may be used to extract a common mode from the output signal of the TIA 210, to be used by the differential amplifier 242 (e.g., linear differential amplifier). Thus, the receiver chip 240 is to convert a single-ended signal to a differential signal. The signal may be DC balanced/averaged, such as by using a LPF to extract the average signal value, for use with the linear differential amplifier 242.

The differential amplifier 242 may be associated with a high quality common mode noise rejection. In an example, a continuous-time linear equalizer (CTLE) may be used to convert the TIA output and DC common mode into differential output, though other implementations may be used. A linear differential amplifier 242 with a high-pass filter may be used to compensate, for example, high frequency losses due to package routes and any bandwidth limitations of the TIA 210. Thus, the package routing and TIA 210 may be designed to be low bandwidth to have a better signal-to-noise ratio (SNR). The single-end to differential conversion through common mode can further ensure that the signals may be amplified differentially at downstream stages in the system 200.

The first capacitor 236 and second capacitor 243 may be placed adjacent to the device(s)/component(s) that the capacitors are concerned with, to reduce a distance from the capacitor and the component(s) on which they act. Capacitors may be chosen to have compatible values that are as high as possible, to provide good references for the very low signals involved (e.g., the low-current signals produced by the optical module 230 and transmitted by the interconnect 220. In an example, the first capacitor 236 may be on the order of micro farads, and the second capacitor 243 (which may be located on the voltage regulator 244 itself), may be on the or of 200 pico farads. Thus, the second capacitor 243 may be provided on-chip (e.g., based on silicon fabrication with the receiver chip 240). The optical module 230 may be assembled from discrete components, thus the first capacitor 236 may be chosen as a larger discrete capacitor element that is provided separately.

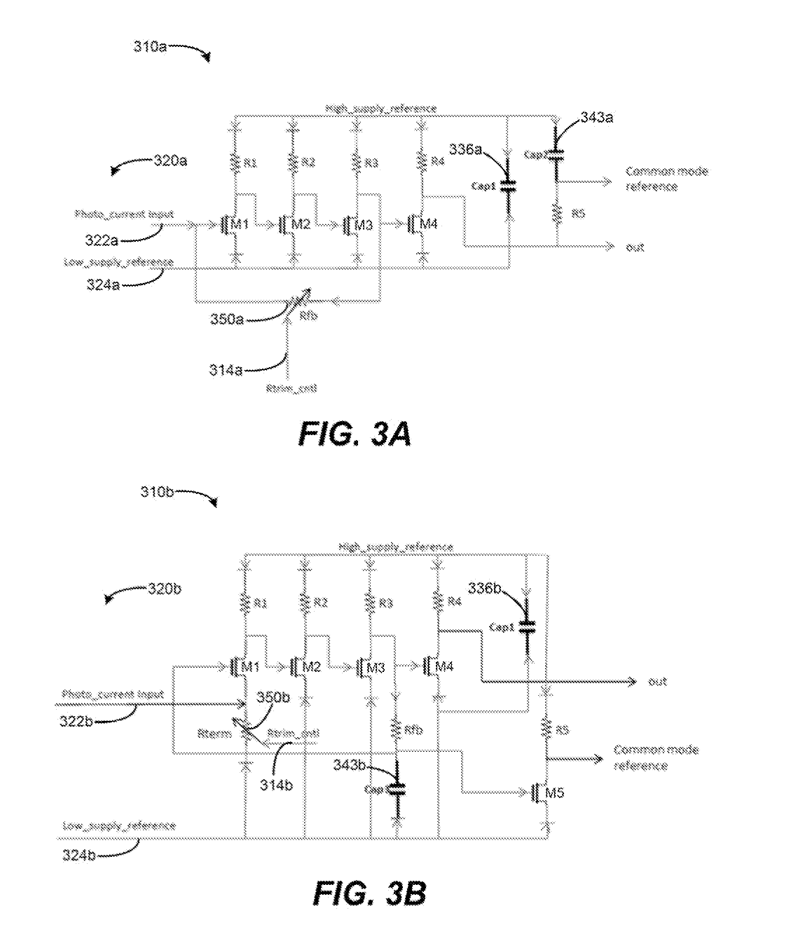

FIG. 3A is a block diagram of a TIA 310a according to an example. TIA 310a Is to interface with impedance control 314a and interconnect 320a, including transmission line 322a and reference ground 324a, to provide a common mode reference and output “out” based on a high supply reference. TIA 310a includes feedback resistor 350a, first capacitor 336a, second capacitor 343a, transistors M1-M4, and resistors R1-R5.

The TIA 310a may be a feedback-based TIA with input impedance programmability, based on the feedback resistor (Rfb) 350a and the impedance control 314a. In an example, an input impedance Rₜᵢₐ, Rfb/(A+1), where A is an open gain associated with the TIA 310a, Rfb is trimmabale by Rtrim_cntl, which may be based on logic or other form of control. Impedance control 314a is to trim Rfb and may trim Rfb so that Rₜᵢₐ=Z0, where Z0 is associated with a transmission line (not shown) to interface with TIA 310a.

Thus, the feedback resistor 350a, and other aspects of the TIA 310a, may serve as an impedance adjuster, that may be part of the TIA 310a. Input impedance of the TIA 310a can be adjusted based on the feedback resistor 350a itself, and/or by adjusting other aspects of the TIA 310a such as the overall gain (e.g., open loop gain) or bias.

Impedance control 314a may be used to adjust the impedance adjuster. For example, the input impedance of the TIA 310a may be unknown at assembly prior to activation, so it may be unknown whether the input impedance meets requirements. An output of the TIA 310a may be examined, e.g., by examining an output eye diagram margin and so on as a way to test the TIA 310a performance. In response, a logic control outside the TIA 310a may provide the Rtrim_cntl signal used for impedance control 314a going to the adjustable feedback resistor 350a.

FIG. 3B is a block diagram of a TIA 310b according to an example. TIA 310b is to interface with impedance control 314b and interconnect 320b, including transmission line 322b and reference ground 324b, to provide a common mode reference and output “out” based on a high supply reference. TIA 310b includes feedback resistor 350b, first capacitor 336b, second capacitor 343b, transistors M1-M5, and resistors R1-R5 and Rfb.

The TIA 310b is an example open-gain TIA with input impedance programmability. An input impedance Rₜᵢₐ=RtermII(1/gₘ 1), and 1/gₘ1>20×Rterm. Therefore, Rₜᵢₐ=Rterm, which is trimmable based on impedance control 314b (Rtrim_cntl) so that Rₜᵢₐ=Z0 (impedance of a transmission line). Thus, the TIA 310b may match an impedance of the transmission line, based on impedance control 314a and an impedance adjuster of the TIA 310b, such as termination resistor 350b and other aspects of the TIA 310b. By matching M4=M5 and R4=R5, level shifting and common mode output are provided.

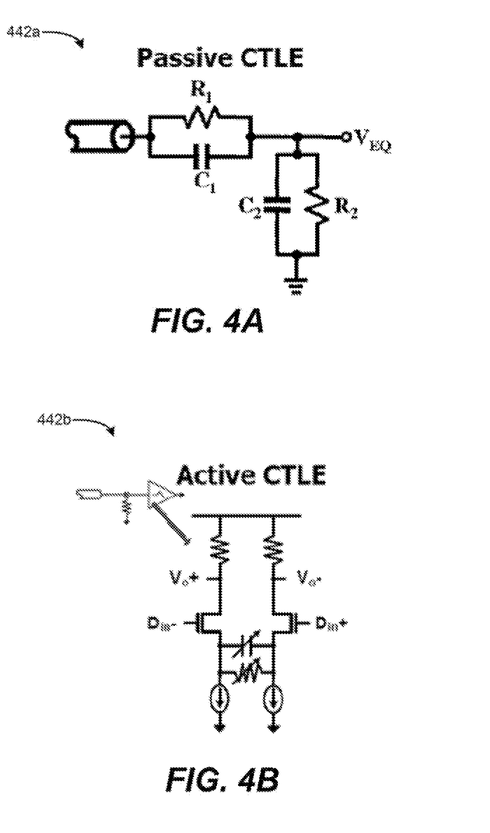

FIG. 4A is a block diagram of a passive Continuous-Time Linear Equalizer (CTLE) 442a according to an example, and FIG. 4B is a block diagram of an active CTLE 442b according to an example. The exemplary CTLEs of FIGS. 4A and 4B may be associated with the differential amplifier described with respect to examples provided above.

The passive CTLE of FIG. 4A may include a passive R-C (or L) circuit as shown, based on R₁, C₁ and R₂, C₂ (or L). The passive circuits can implement a high-pass transfer function to compensate for channel loss. The passive circuits also can cancel both precursor and long-tail intersymbol interference (ISI). Examples may be purely passive (as shown), and also may be combined with an amplifier (e.g., as shown in FIG. 4B) to provide gain. FIGS. 4A and 4B demonstrate various electrical circuits that are novel in view of their use in an optical system/interface as shown, unlike other electrical (i.e., non-optical) high speed interconnects.

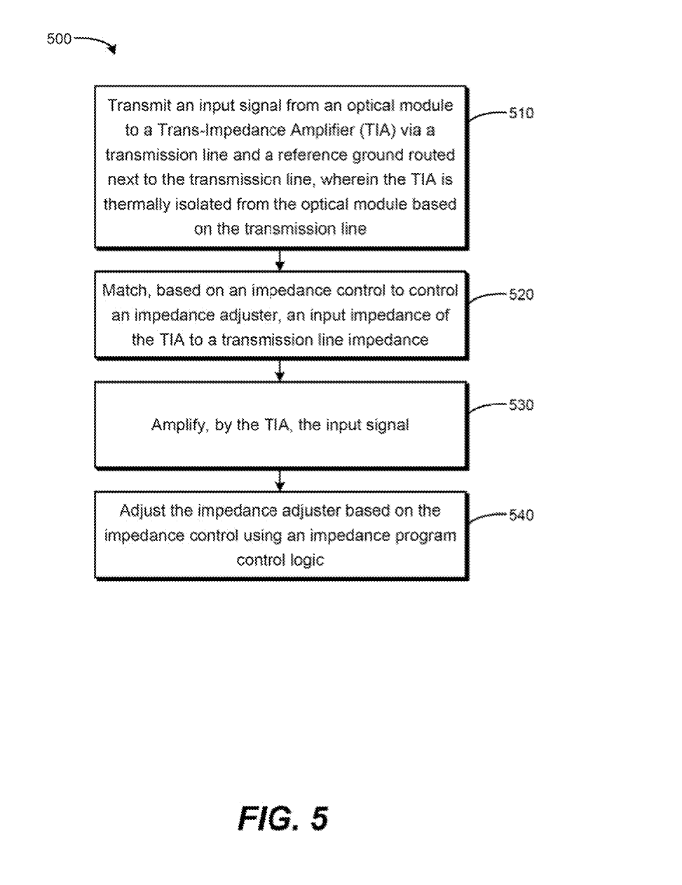

FIG. 5 is a flow chart based on amplifying a input signal according to an example. In block 510, an input signal from an optical module is transmitted to a Trans-Impedance Amplifier (TIA) via a transmission line and a reference ground routed next to the transmission line. The TIA is thermally isolated from the optical module based on the transmission line. In block 520, an input impedance of the TIA is matched to a transmission line impedance, based on an impedance control to control an impedance adjuster. In block 530, the input signal is amplified by the TIA. In block 540, the impedance adjuster is adjusted based on the impedance control using an impedance program control logic.

What is claimed is:

1. A system comprising:
a Trans-Impedance Amplifier (TIA) to amplify an input signal from an optical module, wherein the TIA is to interface with the optical module via a transmission line and a reference ground routed next to the transmission line, to thermally isolate the TIA from the optical module; and
an impedance control to cause an impedance adjuster to match an input impedance of the TIA to a transmission line impedance.

2. The system of claim 1, wherein the TIA is to be integrated into a receiver chip including heat-generating components to be thermally isolated from the optical module, wherein the receiver chip is to have a first thermal solution to be optimized independent from a second thermal solution for the optical module.

3. The system of claim 1 wherein the impedance adjuster is to adjust the input impedance of the TIA to minimize reflection noise associated with the transmission line.

4. The system of aim 1, wherein the impedance adjuster is based trimmable feedback resistor.

5. The system of claim 1, wherein the input in impedance of the TIA is to substantially match an interconnect impedance associated with the transmission line and reference ground.

6. The system of claim 1, further comprising a voltage regulator provide clean supply voltage to the TIA based on a bandgap reference.

7. The system of claim 1, further comprising a capacitor to couple a source voltage for the TIA to the reference ground to minimize capacitive and inductive coupling noises.

8. The system of claim 1, wherein the TIA is to provide single-end to differential conversion through common mode enable differential amplification downstream of the TIA.

9. The system of claim 1, further comprising a linear differential amplifier including a high-pass filter to compensate high frequency loss associated with a package route and bandwidth of the TIA.

10. The system of claim further comprising a Continuous-Time Linear Equalizer (CTLE) to convert a TIA output and DC common mode into a differential output to be processed by blocks downstream of the TIA.

11. An optical receiver system comprising:
an optical module including an optical component to receive an optical signal and generate an input signal;
an interconnect including a transmission line and a reference ground routed next to the transmission line, to transmit the input signal and thermally isolate the optical module; and
a receiver chip including a Trans-Impedance Amplifier (TIA) to amplify the input signal from the interconnect and to match a transmission line impedance based on an impedance control to control an impedance adjuster, wherein the receiver chip is thermally separated from the optical module.

12. The system of claim 11, wherein the optical module is to provide a single-ended mode input signal, and the receiver chip is to provide differential conversion of the input signal based on a common mode.

13. The system of claim 11, wherein the receiver chip is an application-specific integrated circuit (ASIC) based on a Complementary metal-oxide-semiconductor (CMOS) process.

14. A method, comprising:
transmitting an input signal from an optical module to a Trans-Impedance Amplifier (TIA) via a transmission line and a reference ground routed next to the transmission line, wherein the TIA is thermally isolated from the optical module based on the transmission line;
matching, based on an impedance control to control an impedance adjuster, an input impedance of the TIA to a transmission line impedance; and
amplifying, by the TIA, the input signal.

15. The method of claim 14, further comprising adjusting the impedance adjuster based on the impedance control using an impedance program control logic.
